(19) United States
(12) Patent Application Publication
(10) Pub. No.: US 2016/0195897 A1
(43) Pub. Date: Jul. 7, 2016

(54) MULTI-DEVICE DOCKING STATION

(71) Applicant: ACCO Brands Corporation, Lake Zurich, IL (US)

(72) Inventors: Todd C. Robinson, Belmont, CA (US); Louie Yao, Foster City, CA (US); Jonathan Stacey, Vancouver (CA)

(21) Appl. No.: 14/985,643

(22) Filed: Dec. 31, 2015

Related U.S. Application Data
(60) Provisional application No. 62/099,267, filed on Jan. 2, 2015.

(51) Int. Cl. G06F 1/16; G06F 13/40

(52) U.S. Cl. CPC G06F 1/1632; G06F 13/4081

(57) ABSTRACT

A docking station includes a first port configured to couple to a display, a second port configured to couple to a peripheral device, a first connector configured to receive a first video signal from a first electronic device, and a second connector configured to receive a second video signal from a second electronic device. The docking station also includes a control circuit having a video processor operable to decompress video signals, a first electrical communication path formed by the first connector and the first port, and a second electrical communication path formed by the second connector, the video processor, and the first port. The first electrical communication path selectively transmits the first video signal from the first connector to the first port, and the second electrical communication path selectively transmits the second video signal from the second connector, through the video processor, and to the first port.

### CROSS-REFERENCE TO RELATED APPLICATIONS

This application claims priority benefit to U.S. Provisional Application No. 62/099,267 filed on Jan. 2, 2015, the entire contents of which are herein incorporated by reference.

### FIELD OF INVENTION

The present invention relates to docking stations. In particular, the invention relates to docking stations that manage access of peripheral devices and/or functionalities to connected electronic devices.

### SUMMARY

In one embodiment, the invention provides a docking station for use with a first electronic device, a second electronic device, a display, and a peripheral device. The docking station includes a first port configured to couple to the display, and a second port configured to couple to the peripheral device. The docking station also includes a first connector configured to receive a first video signal from the first electronic device, and a second connector configured to receive a second video signal from the second electronic device. The docking station further includes a control circuit coupled to the first port, the second port, the first connector, and the second connector. The control circuit includes a video processor operable to decompress video signals, a first electrical communication path formed by the first connector and the first port, and bypassing the video processor, and a second electrical communication path formed by the second connector, the video processor, and the first port. The first electrical communication path selectively transmits the first video signal from the first connector to the first port. The second electrical communication path selectively transmits the second video signal from the second connector, through the video processor, and to the first port.

In another embodiment, the invention provides a method of sharing a display and a peripheral device among a first electronic device and a second electronic device using a docking station. The docking station includes a first port, a second port, a first connector, a second connector, and a control circuit having a video processor that is operable to decompress video signals. The method includes coupling the display to the first port of the docking station, coupling the peripheral device to the second port of the docking station, coupling the first electronic device to the first connector of the docking station, and coupling the second electronic device to the second connector of the docking station. The method also includes receiving, by the first connector, a first video signal from the first electronic device and receiving, by the second connector, a second video signal from the second electronic device. The method further includes selectively transmitting the first video signal to the display via a first electrical communication path formed by the first connector and the first port, and bypassing the video processor of the control circuit, and selectively transmitting the second video signal to the display via a second electrical communication path formed by the second connector, the video processor, and the first port. The method also includes decompressing, by the video processor, the second video signal.

Other aspects of the invention will become apparent by consideration of the detailed description and accompanying drawings.

### BRIEF DESCRIPTION OF THE DRAWINGS

FIG. 1 illustrates a docking station according to one embodiment of the invention.

FIG. 2 is a schematic diagram of the docking station shown in FIG. 1.

FIG. 3 is a flowchart depicting a method implemented by a first connection management circuit of the docking station.

FIG. 4 is a schematic diagram of the docking station when only a first electronic device is connected.

FIG. 5 is a schematic diagram of the docking station when only a second electronic device is connected.

FIG. 6 is a flowchart depicting a method implemented by a second connection management circuit of the docking station.

FIG. 7 is a perspective view of the docking station connected to the first electronic device.

FIG. 8 is a perspective view of the docking station connected to the second electronic device.

FIG. 9A is a perspective view of the docking station connected to the first electronic device through an OEM dock.

FIG. 9B is a perspective view of the docking station connected to the first electronic device through a USB PC dock.

FIG. 10 is a perspective view of the docking station connected to the second electronic device.

FIG. 11 shows an exemplary graphical user interface to control connections within the docking station.

FIG. 12 is a flowchart illustrating the operation of the docking station.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

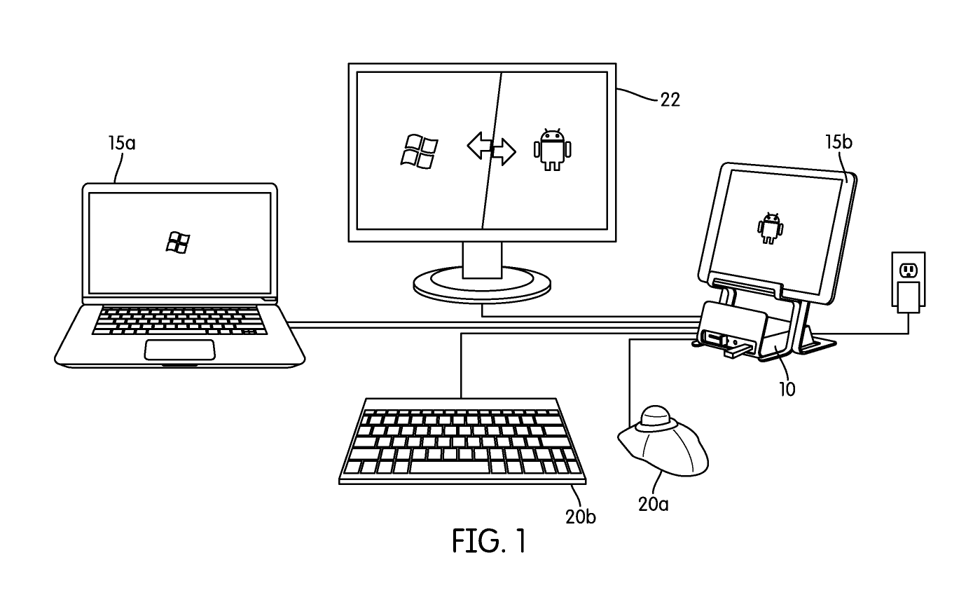

FIG. 1 illustrates a docking station 10. The docking station 10 enhances a user's interaction with different electronic devices 15a-b by providing access to different peripheral devices 20a-b and/or external displays 22. The electronic devices 15a-b use different connectors to couple to the docking station 10 and may run different operating systems. Despite the electronic devices 15a-b running different operating systems, the docking station 10 shares the peripheral devices 20a-b and/or the display 22 between the electronic devices 15a-b. In other words, the docking station 10 includes different hardware and/or software to interact and communicate with different operating systems such as, for example, Android, iOS, Windows, Mac OS, Linux, etc. A user can separately or jointly control which peripheral devices 20a-b and the display 22 that are associated with each electronic device 15a-b. The docking station 10 also provides data communication between a first electronic device 15a and a second electronic device 15b to transfer files between the electronic devices 15a-15b.

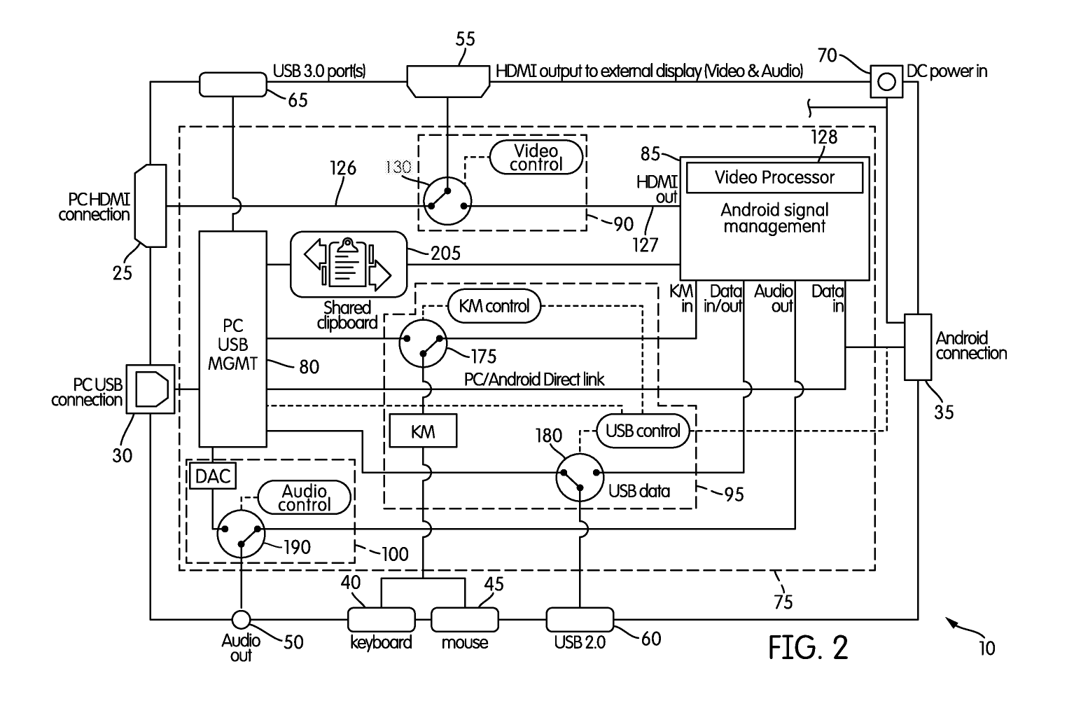

As shown in FIG. 2, the docking station 10 includes a video connector 25, a first data connector 30, a second data connector 35, a first peripheral device port 40, a second peripheral device port 45, an audio output port 50, a video output port 55, input/output ports 60, 65, a power input 70, and a control circuit 75. The video connector 25 and the first data connector 30 electrically couple the first electronic device 15a to the docking station 10. In the illustrated embodiment, the first electronic device 15a is a personal computer. In other embodiments, the first electronic device 15a can be a laptop computer or a desktop computer. In the illustrated embodiment, the video connector 25 is a high-definition multimedia interface (HDMI) connector. In other embodiments, the video connector 25 may be an analog video connector such as a video graphics array (VGA) connector, or a different digital video connector such as a DisplayPort (DP) or digital video interface (DVI) connector. The video connector 25 couples (e.g., via a cable) to a compatible port on the first electronic device 15a. The video connector 25 is able to exchange (i.e., send and receive) uncompressed video output (e.g., video signals) between the first electronic device 15a and the docking station 10, thereby inhibiting degradation of video quality when video signals are exchanged.

In the illustrated embodiment, the first data connector 30 is a universal serial bus (USB) connector that enables the docking station 10 and the first electronic device 15a to exchange (i.e., send and receive) data (e.g., data signals). In particular, the first data connector 30 may be a type-B USB connector. In other embodiments, the first data connector 30 may be a different analog or digital data connector (e.g., a type-A or type-C USB connector). The first data connector 30 couples (e.g., via a cable) to a compatible port on the first electronic device 15a. In some embodiments, the first data connector 30 may also transfer power between the first electronic device 15a and the docking station 10.

In the illustrated embodiment, the video connector 25 and the first data connector 30 are each different types of connectors. For example, the video connector 25 is a first type of connector and the first data connector 30 is a second type of connector that is different than the first type of connector. In some embodiments, the video connector 25 and the first data connector 30 are combined into a single connector such that both uncompressed video signals and data signals are transmitted through the same connector such as, for example, a type-C USB connector.

The second data connector 35 electrically couples the second electronic device 15b to the docking station 10 and enables the second electronic device 15b to communicate (e.g., exchange video and data signals) with the docking station 10. In the illustrated embodiment, the second electronic device 15b includes a tablet computer. In other embodiments, the second electronic device 15b can alternatively include a smartphone, a smartwatch, an electronic reader such as the Kindle®, a portable media player, and the like. In the illustrated embodiment, the second data connector 35 is a proprietary connector used by specific manufacturers. For example, the second data connector 35 may be a proprietary connector used by Apple Inc. to connect to IPADs, IPODs, IPHONEs, and the like. In other embodiments, the second data connector 35 includes a universal connector used with a variety of different electronic devices. For example, the second data connector 35 may be a mini-USB connector, a type-B USB connector, a type-C USB connector, or another connector that is compatible with smartphones and tablet computers from different manufacturers.

In the illustrated embodiment, the second data connector 35 receives a physical connector from the second electronic device 15b. In other embodiments, however, the second data connector 35 includes a wireless communication unit that establishes wireless communication with the second electronic device 15b. The wireless communication unit may be, for example, a Bluetooth® transceiver, a Near-Field communication transceiver, a Wi-Fi transceiver, and the like. Therefore, the second data connector 35 is operable to send and receive data and/or video signals wirelessly to and from the second electronic device 15b (e.g., using technology such as, for example, Miracast®). The second data connector 35 can send both compressed and uncompressed video signals with the second electronic device 15b through the use of a physical connector and/or a wireless connector, as described above.

As discussed above, each of the connectors described above (i.e., the video connector 25, the first data connector 30, and the second data connector 35) can each be a different type of connector. For example, in the illustrated embodiment, the video connector 25 is an HDMI first type of connector using a first communication protocol, the first data connector 30 is a USB second type of connector using a second communication protocol, and the second data connector 35 is a proprietary third type of connector using a third communication protocol. Therefore, the docking station 10 is operable to communicate in different communication protocols with the first electronic device 15a and the second electronic device 15b.

The first and second peripheral device ports 40, 45 electrically couple different peripheral devices 20a-b to the docking station 10. The peripheral devices 20a-b include devices that enhance the functionality and/or the user interaction experience with the docking station 10, the first electronic device 15a, or the second electronic device 15b. In the illustrated embodiment, the peripheral devices 20a-b include a mouse 20a and a keyboard 20b (FIG. 1). In other embodiments, however, the peripheral devices 20a-b can alternatively or additionally include other pointing devices, a number keypad, a fingerprint reader/scanner, an external CD/DVD drive, a desk accessory, a stylus, a touch pad, and the like. As shown in FIG. 2, the first and second peripheral device ports 40, 45 are jointly controlled such that both of the peripheral devices 20a-b are associated with either the first electronic device 15a or the second electronic device 15b. In other embodiments, each peripheral device port 40, 45 is independently controlled such that the first peripheral device 20a may be associated with the first electronic device 15a and the second peripheral device 20b may be associated with the second electronic device 15b.

The audio output port 50 electrically couples the docking station 10 with an audio device such as, for example, a speaker, headphones, earphones, and the like. The audio output port 50 is selectively coupled to one of the first electronic device 15a and the second electronic device 15b to receive audio signals from the first electronic device 15a or the second electronic device 15b. In the illustrated embodiment, the audio output port 50 is a digital output connector mini-stereo connector. In other embodiments, the audio output port 50 may be an analog or digital audio connector such as, for example, a fire wire connector/port, an RCA-type connector/port, a multi-channel connector/port, an optical connector/port, a coaxial connector/port, a speaker plug or speaker wire connector/port, and the like.

The video output port 55 electrically couples the docking station 10 with the external display 22 (FIG. 1). The video output port 55 is selectively coupled to one of the first electronic device 15a and the second electronic device 15b to receive video signals from the first electronic device 15a or the second electronic device 15b and transmit them to the display 22. In the illustrated embodiments, the video output port 55 receives an HDMI connector. In other embodiments, the video output port 55 may output analog or digital signals and may receive connectors such as, for example, a VGA connector, a DP connector, a DVI connector, a fire wire connector, and the like. In some embodiments, the display 22 replaces the display of the first electronic device 15a or the second electronic device 15b. In other embodiments, the display 22 is used in addition to the display of the first electronic device 15a or the display of the second electronic device 15b.

The input/output ports 60, 65 provide a plurality of different ports accessible to the first electronic device 15a and the second electronic device 15b. In the illustrated embodiment, the input/output ports 60, 65 include USB 2.0 and USB 3.0 connectors. The input/output ports 60, 65 allow for other devices, such as a mass storage device, to be connected to the docking station 10 and to be associated with the first electronic device 15a or the second electronic device 15b. The input/output ports 60, 65 allow data transfer between a connected device (e.g., a mass storage device) and the first electronic device 15a or the second electronic device 15b. In some embodiments, the input/output ports 60, 65 simply replicate ports available on the first electronic device 15a or the second electronic device 15b. In other embodiments, the input/output ports 60, 65 provide additional ports not found on the first electronic device 15a or the second electronic device 15b and therefore increase the functionality of the first electronic device 15a and/or the second electronic device 15b. For example, the input/output ports 60, 65 may offer faster and/or different protocols than ports found on the first electronic device 15a or the second electronic device 15b.

The power input 70 provides power to the docking station 10. In the illustrated embodiments, the power input 70 includes a connector and/or port configured to connect to an external power source such as a wall outlet. In the illustrated embodiment, the docking station 10 receives AC power from the external power source. Accordingly, the docking station 10 may also include a power converter to convert the AC power from the external power source to DC power of adequate amplitude for powering the electrical components of the docking station 10. For example, the power converter may include a rectifier to convert the AC power to DC power and a DC-to-DC converter to then set the DC power to the appropriate power level for the electrical components of the docking station 10. In other embodiments, the power input 70 may include a battery receptacle to receive a battery for powering the docking station 10. In some embodiments, the battery may be removable from the docking station 10 for easy replacement. In other embodiments, the battery is not removable, but instead receives power and is charged through an external power source (e.g., a wall outlet). In some embodiments, the docking station 10 may use the external power source as a primary power source and may switch to using the battery in case the primary power source is interrupted. In the illustrated embodiment, the power input 70 is directly connected to the second electronic device 15b to provide power to the second electronic device 15b if needed. In some embodiments, the power input 70 may alternatively or additionally be coupled to the first electronic device 15a to provide power to the first electronic device 15a.

As shown in FIG. 2, the control circuit 75 is coupled to the different connectors and/or ports 25-70 and controls the interconnections between the different peripheral devices 20a-b, the display 22, and the electronic devices 15a-b. The control circuit 75 includes a first connection management circuit 80, a second connection management circuit 85, a video output control circuit 90, a peripheral device control circuit 95, and an audio control circuit 100. The first and second connection management circuits 80, 85 are configured to control and transfer data signals between the peripheral device ports 40, 45, the audio output port 50, the input/output ports 60, 65, and the associated electronic device 15a-b. The control circuits 90-100 are configured to receive user inputs and associate and/or electrically couple the associated port(s) 40, 45, 50, 55, 60, 65 with the first electronic device 15a or the second electronic device 15b in response to the user inputs. As shown in FIG. 2, each control circuit 90-100 can be independently controlled and associated with one of the first electronic device 15a or the second electronic device 15b.

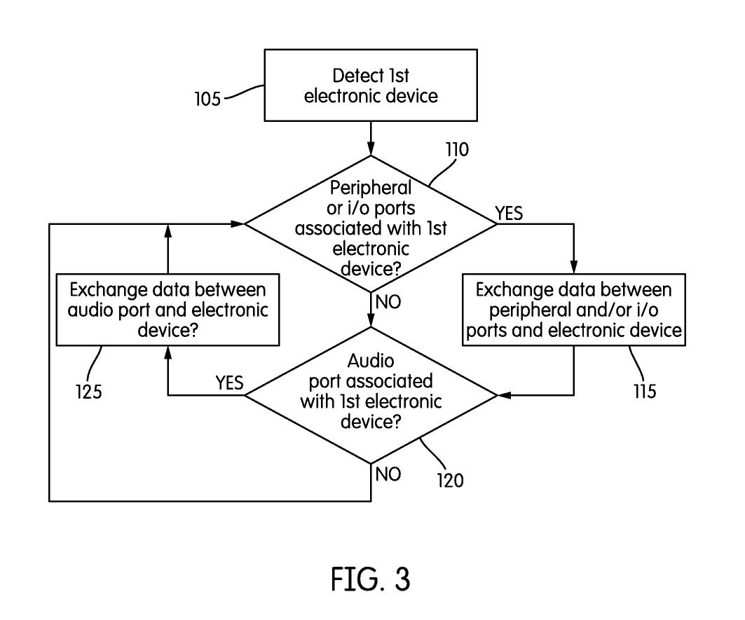

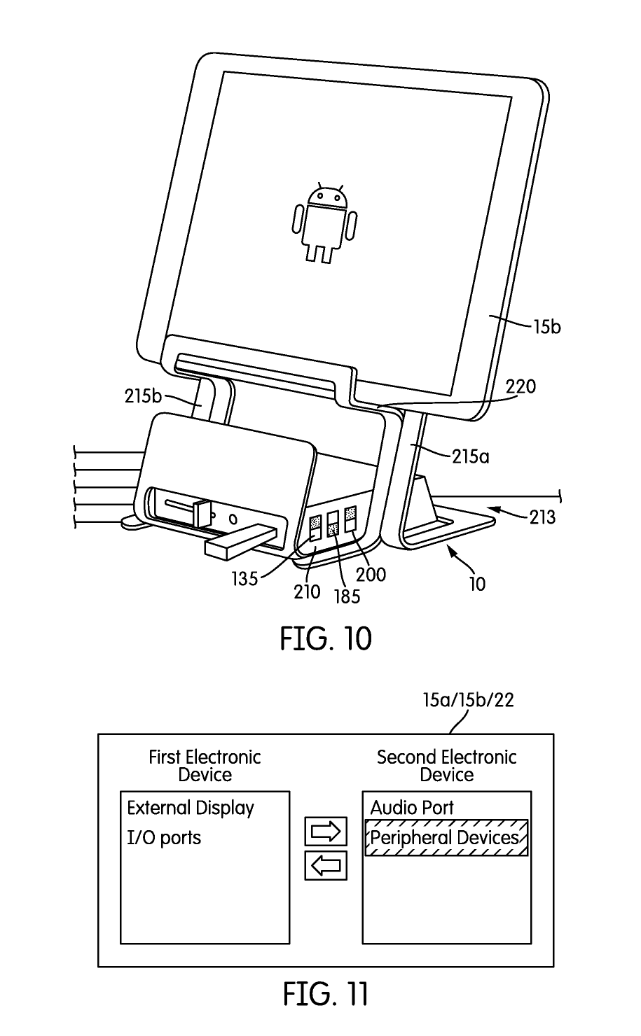

The first connection management circuit 80 is configured to manage data signals associated with the first electronic device 15a, as illustrated in FIG. 3. The first connection management circuit 80 may be implemented by a microprocessor, a microcontroller, or a control circuit. In some embodiments, the first connection management circuit 80 includes a combination of hardware and software to make and break different connections in the docking station 10. In the illustrated embodiment, the first connection management circuit 80 is coupled to the first data connector 30, the peripheral control circuit 95, and the audio control circuit 100. The first connection management circuit 80 is configured to automatically detect when the first electronic device 15a is connected to the docking station 10 (step 105). The first connection management circuit 80 determines that the first electronic device 15a is connected to the docking station 10 when the first connection management circuit 80 receives a data signal through the first data connector 30. In some embodiments, the first connection management circuit 80 may additionally or alternatively detect that the first electronic device 15a is connected the docking station 10 by monitoring the state of different control actuators 135, 185, 200, 203 (FIG. 10) that control the switching of the docking station 10.

The first connection management circuit 80 then determines whether the peripheral control circuit 95 indicates that the peripheral ports 40, 45 or the input/output ports 60, 65 are to be associated with the first electronic device 15a (step 110). If the peripheral ports 40, 45 or the input/output ports 60, 65 are to be associated with the first electronic device 15a, the first connection management circuit 80 enables data exchange between the first data connector 30 and the peripheral ports 40, 45 and/or input/output ports 60, 65 (step 115). If the peripheral ports 40, 45 or the input/output ports 60, 65 are not associated with the first electronic device 15a, the first connection management circuit 80 simply proceeds to step 120. The first connection management circuit 80 also determines whether the audio control circuit 100 indicates that the audio output port 50 is associated with the first electronic device 15a (step 120). If the audio output port 50 is associated with the first electronic device 15a, the first connection management circuit 80 enables data exchange between the first data connector 30 and the audio output port 50 (step 125). If, on the other hand, the audio output port 50 is not associated with the first electronic device 15a, data is not exchanged between the audio output port 50 and the first electronic device 15a.

Although the first connection management circuit 80 has been described as making determination steps 110, 120, in some embodiments, the first connection management circuit 80 simply includes a set of switches and/or connections that do not carry out these determination steps 110, 120. Rather, the determination steps 110, 120 are made by the separate control circuits 90-100, and the first connection management circuit 80 simply provides the electrical connections between the first data connector 30 and the control circuits 90-100.

In the illustrated embodiment, the video output control circuit 90 operates independently from the first connection management circuit 80. As shown in FIG. 2, the video output control circuit 90 is directly connected to the video connector 25 and the second connection management circuit 85. Therefore, the docking station 10 allows separate and independent control of the video output and the rest of the peripheral devices and/or ports. The separate connection between the video connector 25 and the video output control circuit 90 allows one electronic device 15a-b (e.g., the first electronic device 15a) to be connected to and associated with the external display 22, while the other electronic device 15a-b (e.g., the second electronic device 15b) is associated with the peripheral devices 20a-b and/or the audio output port 50.

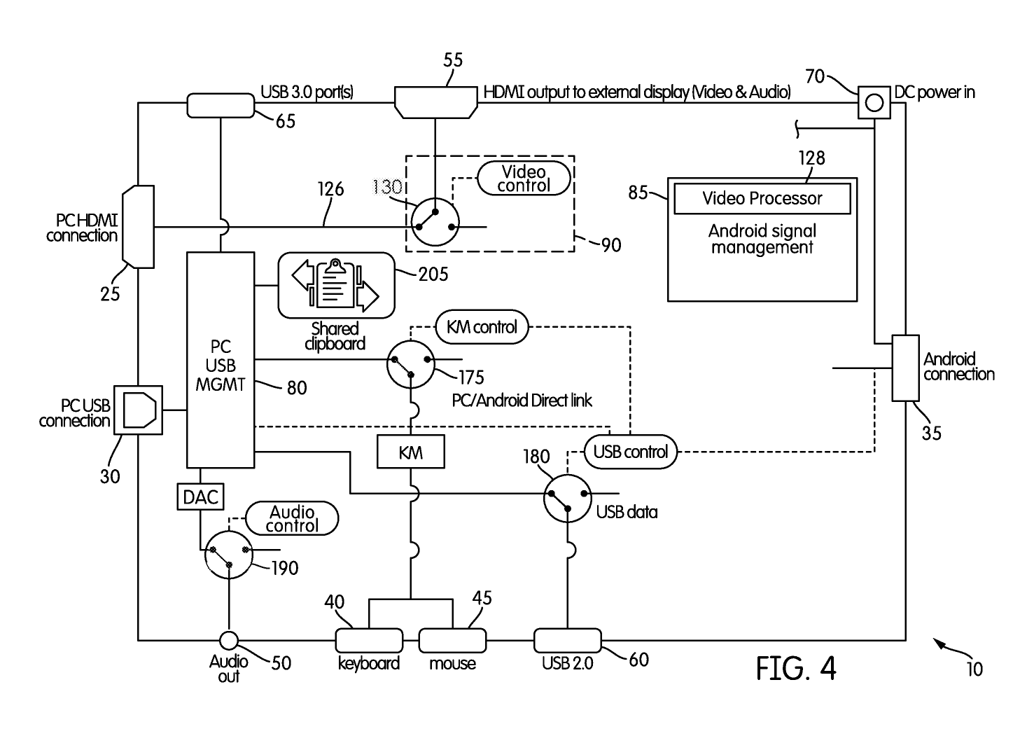

As shown in FIG. 2, the video output control circuit 90 includes a first electrical communication path 126, a second electrical communication path 127, and a two-position electronic switch 130, or a different electronic device performing a similar function (e.g., a multiplexer), to selectively associate (e.g., connect) the external display 22 to one of the first electronic device 15a or the second electronic device 15b. The first electrical communication path 126 is formed by the video connector 25, the electronic switch 130, and the video output port 55. FIGS. 2 and 4 show the electronic switch 130 in a first position. In the first position, the electronic switch 130 completes the first electrical communication path 126, which connects the video output port 55 to the video connector 25. Accordingly, when the electronic switch 130 is in the first position, the video output control circuit 90 selectively transmits video signals from the video connector 25 (i.e., from the first electronic device 15a) to the video output port 55 (i.e., to the external display 22).

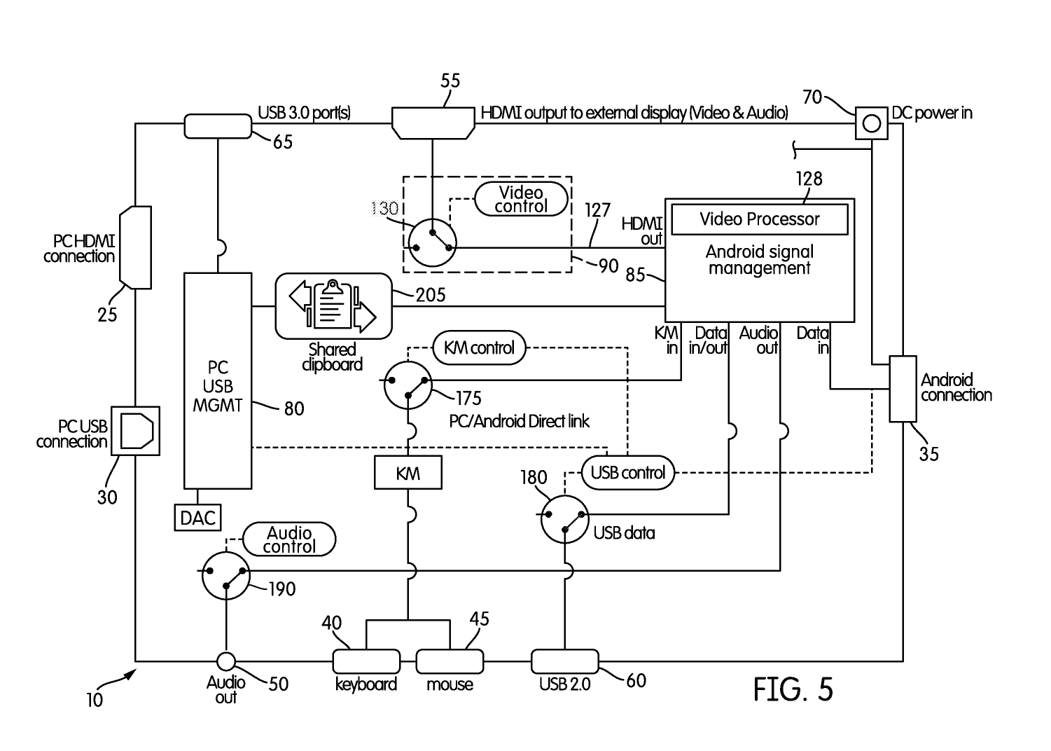

The second electrical communication path 127 is formed by the second data connector 35, a video processor 128 included in the second connection management circuit 85, and the video output port 55. The video processor 128 is configured to decompress video signals received from the second data connector 35. In the illustrated embodiment, the video processor 128 is included in the second connection management circuit, but may be a separate component in other embodiments. In the second position (FIG. 5), the electronic switch 130 completes the second electrical communication path 127, which connects the video output port 55 to the second data connector 35. Accordingly, when the electronic switch 130 is in the second position, the video output control circuit 90 selectively transmits video signals from the second data connector 35 (i.e., from the second electronic device 15b) to the video output port 55 (i.e., to the external display 22). Notably, the first electrical communication path 126 bypasses the video processor 128 since the video signals received by the video connector are uncompressed video signals. In some embodiments, the video output control circuit 90 includes a three-position switch instead of the two-position switch 130 and allows the second electronic device 15b to be connected directly with the first electronic device 15a to allow for exchange of video data. In such embodiments, the video output control circuit 90 only partially completes the first electrical communication path 126 and the second electrical communication path 127. In such embodiments, the second electronic device 15b (e.g., a tablet computer) can use the first electronic device 15a (e.g., a laptop computer) to amplify its display without the need for the external display 22.

The electronic switch 130 is controlled by an actuator 135 (FIG. 10) on the docking station 10. In the illustrated embodiment, the actuator 135 is a toggle switch that moves between two different positions. In a first position, the actuator 135 causes the electronic switch 130 to be in the first position, thereby connecting the video output port 55 to the video connector 25. In a second position, the actuator 135 causes the electronic switch 130 to be in the second position, thereby connecting the video output port 55 to the second connection management circuit 85. In other embodiments, the actuator 135 can be a push-button, a slider switch, a dip switch, a touch pad, and the like.

The second connection management circuit 85 is configured to manage data signals associated with the second electronic device 15b. The second connection management circuit 85 may be implemented by a microprocessor, a microcontroller, or a control circuit. In some embodiments, the second connection management circuit 85 includes a combination of hardware and software to make and break different connections in the docking station 10. In the illustrated embodiment, the second connection management circuit 85 is coupled to the second data connector 35, the video output control circuit 90, the peripheral control circuit 95, and the audio control circuit 100. As discussed above, the second connection management circuit 85 includes the video processor 128 that is operable to decompress the video signals received from the second electronic device 15b through the second data connector 35. As also discussed above, the video processor 128 forms part of the second electrical communication path 127.

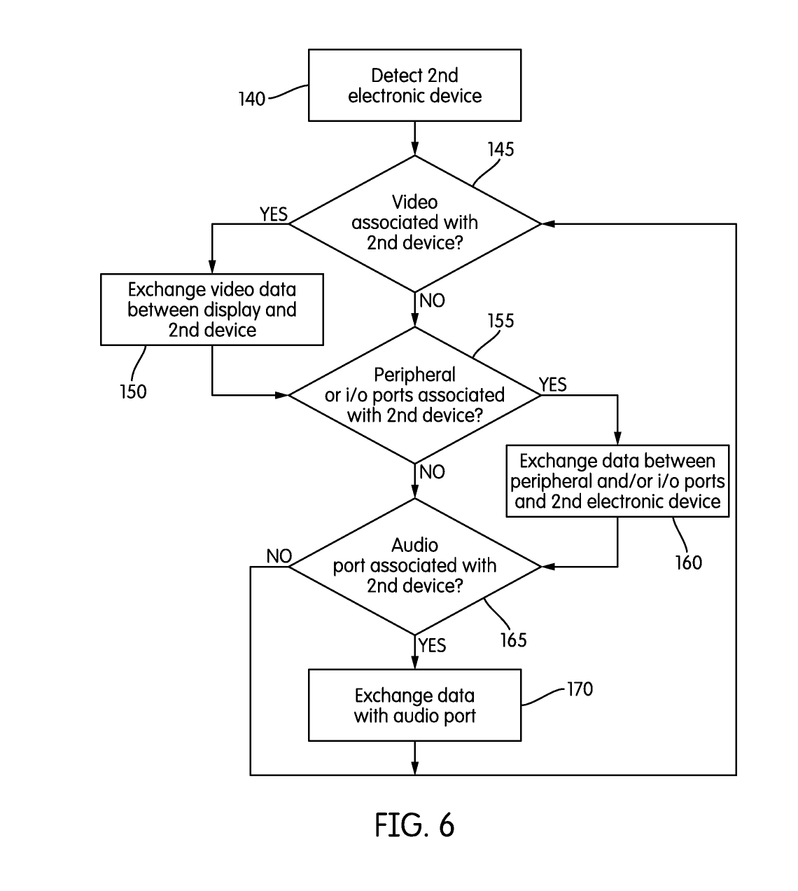

As shown in FIG. 6, the second connection management circuit 85 is configured to automatically detect when the second electronic device 15b is connected to the docking station 10 (step 140). The second connection management circuit 85 detects that the second electronic device 15b is connected to the docking station 10 when the second connection management circuit 85 receives a data signal through the second data connector 35. In some embodiments, the second connection management circuit 85 may additionally or alternatively detect that the second electronic device 15b is connected the docking station 10 by monitoring the state of different control actuators 135, 185, 200, 203 (FIG. 10) that control the switching of the docking station 10. The second connection management circuit 85 then communicates with the video output control circuit 90 and determines whether the electronic switch 130 is in the second position, thereby connecting the video output port 55 to the second connection management circuit 85 (step 145). If the second connection management circuit 85 determines that the electronic switch 130 is in the second position, the second connection management circuit 85 allows video data to be exchanged between the video output port 55 and the second data connector 35 (step 150). In contrast, if the second connection management circuit 85 determines that the electronic switch 130 is in the first position, video data is not exchanged between the second data connector 35 and the video output port 55.

The second connection management circuit 85 then determines whether the peripheral control circuit 95 indicates that the peripheral ports 40, 45 or the input/output ports 60, 65 are to be associated with the second electronic device 15b (step 155). If the peripheral ports 40, 45 or the input/output ports 60, 65 are to be associated with the second electronic device 15b, the second connection management circuit 85 enables data exchange between the second data connector 35 and the peripheral ports 40, 45 and/or input/output ports 60, 65 (step 160). If the peripheral ports 40, 45 or the input/output ports 60, 65 are not associated with the second electronic device 15b, the second connection management circuit 85 simply proceeds to step 165. The second connection management circuit 85 also determines whether the audio control circuit 100 indicates that the audio output port 50 is associated with the second electronic device 15b (step 165). If the audio output port 50 is associated with the second electronic device 15b, the second connection management circuit 85 enables data exchange between the second data connector 35 and the audio output port 50 (step 170). If, on the other hand, the audio output port 50 is not associated with the second electronic device 15b, data is not exchanged between the audio output port 50 and the second electronic device 15b.

Although the second connection management circuit 85 has been described as making determination steps 145, 155, 165, in some embodiments, the second connection management circuit 85 simply includes a set of switches and/or connections that do not carry out these determination steps 145, 155, 165. Rather, the determination steps 145, 155, 165 are made by the separate control circuits 90-100, and the second connection management circuit 85 provides the electrical connections between the second data connector 35 and the control circuits 90-100.

Referring back to FIG. 2, the peripheral control circuit 95 controls whether the peripheral devices 20a-b and the input/output ports 60, 65 are associated with the first electronic device 15a or the second electronic device 15b. As shown in FIG. 2, the peripheral control circuit includes a first switch 175 that controls whether the peripheral devices 20a-b are associated with the first electronic device 15a or the second electronic device 15b and a second switch 180 that controls whether the input/output ports 60, 65 are associated with the first electronic device 15a or the second electronic device 15b. In the illustrated embodiment, the first switch 175 is a two-position electronic switch. In a first position (FIGS. 2 and 4), the first switch 175 connects the peripheral devices 20a-b to the first connection management circuit 80, effectively connecting the peripheral devices 20a-b to the first electronic device 15a. In a second position (FIG. 5), the first switch 175 connects the peripheral devices 20a-b to the second connection management circuit 85, effectively connecting the peripheral devices 20a-b to the second electronic device 15b.

In the illustrated embodiment, the second switch 180 is also a two-position electronic switch. In a first position (FIGS. 2 and 4), the second switch 180 connects the data ports 60, 65 to the first connection management circuit 80, thereby connecting the input/output ports 60, 65 to the first electronic device 15a. In a second position (FIG. 5), the second switch 180 connects the input/output ports 60, 65 to the second connection management circuit 85, thereby connecting the input/output ports 60, 65 to the second electronic device 15b. In the illustrated embodiment, one of the input/output port 65 is connected to the first connection management circuit 80 regardless of the position of the second switch 180, while another input/output port 60 is selectively connected to the first or second electronic device 15a, 15b based on the position of the second switch 180. Although the first switch 175 and the second switch 180 have been described as two-position electronic switches, the switches 175, 180 can be replaced by another component performing a similar action such as, for example, a multiplexer, or logic in a controller.

In the illustrated embodiment, the first switch 175 and the second switch 180 are controlled by a single actuator 185 (FIG. 10) on the docking station 10. In the illustrated embodiments, the actuator 185 is a toggle switch that moves between two different positions. In a first position, the actuator 185 causes both the first switch 175 and the second switch 180 to be in the first position and connected to the first electronic device 15a. In a second position, the actuator 185 causes both the first switch 175 and the second switch 180 to be in the second position and connected to the second electronic device 15b. In other embodiments, the actuator 185 may be a four-position slider switch to enable separate control of the peripheral devices 20a-b and the input/output ports 60, 65. In such embodiments, the actuator 185 may be movable between a first position in which both the peripheral devices 20a-b and the input/output ports 60, 65 are associated with the first electronic device 15a, a second position in which the peripheral devices 20a-b are associated with the first electronic device 15a and the input/output ports 60, 65 are associated with the second electronic device 15b, a third position in which the peripheral devices 20a-b are associated with the second electronic device 15b and the input/output ports 60, 65 are associated with the first electronic device 15a, and a fourth position in which both the peripheral devices 20a-b and the input/output ports 60, 65 are associated with the second electronic device 15b. In other embodiments, the peripheral devices 20a-b and the input/output ports 60, 65 are controlled by different actuators on the docking station 10 such that the peripheral devise 20a-b and the input/output ports 60, 65 can be individually controlled.

In the illustrated embodiment, the peripheral control circuit 95 is also connected directly with the second data connector 35 such that the peripheral devices 20a-b and/or the input/output ports 60, 65 are automatically associated with the second electronic device 15b if or when the second electronic device 15b is connected to the docking station 10.

Referring back to FIG. 2, the audio output control circuit 100 controls whether the first electronic device 15a or the second electronic device 15b provide an audio output to the audio output port 50. The audio output control circuit 100 includes an audio switch 190, or a different electronic device performing a similar function (e.g., a multiplexer). The audio switch 190 selectively associates (e.g., connects) the audio output port 50 to one of the first electronic device 15a or the second electronic device 15b. In a first position (FIGS. 2 and 4), the audio switch 190 connects the audio output port 50 to the first electronic device 15a. In the illustrated embodiment, the docking station 10 also includes a digital-to-analog converter to convert digital signals into analog audio signals. In a second position (FIG. 5), the audio switch 190 connects the audio output port 50 to the second electronic device 15b.

The audio switch 190 is controlled by an actuator 200 (FIG. 10) on the docking station 10. In the illustrated embodiment, the actuator 200 is a toggle switch that moves between two different positions. In a first position, the actuator 200 causes the audio switch 190 to be in the first position, thereby connecting the audio output port 50 to the first electronic device 15a. In a second position, the actuator 200 causes the audio switch 190 to be in the second position, thereby connecting the audio output port 50 to the second connection management circuit 85. In other embodiments, the actuator 200 can be a push-button, a slider switch, a dip switch, a touch pad, and the like.

Implementing separate control circuits to manage the video, audio, and peripheral connections gives users flexibility in defining their workspace. For example, audio signals from the first electronic device 15a or the second electronic device 15b can be selectively sent to the audio port 50 and transferred to an external audio device (e.g., a speaker), allowing a user to select which device 15a-b is the source of the audio signals (e.g., music data/signals, calendar notifications, application notifications, etc.). The audio signals can also be mixed at different levels. For example, while the second electronic device 15b may provide media (e.g., music) to the audio port 50, the first electronic device 15a may provide calendar notifications to the audio port 50 at the same time.

A user can also selectively associate the external display 22 with the first electronic device 15a and the peripheral devices 20a-b with the second electronic device 15b. For example, the first electronic device 15a may be selected to connect to the video output port 55 and send video signals to the display 22, while the peripheral devices 20a-b can be selected to interact with the second electronic device 15b. This may, for example, allow a user to respond to small matters (e.g., a quick email or chat message) on the second electronic device 15b while minimally disrupting work or displays on the first electronic device 15a. In other situations, however, the user may wish to send video signals from the second electronic device 15b to the video output port 55 to utilize the external display 22 to provide a larger screen for viewing media and experience enhanced productivity on applications such as e-mail.

Although the docking station 10 has been described in the illustrated embodiment as having three actuators 135, 185, 200 that are controlled separately, the docking station 10 may also include a master actuator 203 (FIG. 10) to collectively control the connections to the peripheral ports 40, 45, the audio output port 50, the video output port 55, and the input/output ports 60, 65. In other words, by operating the master actuator 203, a user can easily switch all of the additional functionality provided by the docking station 10 from the first electronic device 15a to the second electronic device 15b, or vice versa. In some embodiments, the master actuator 203 is the only control accessible to the user, and individual control of additional functionality provided by the docking station 10 is not controlled by the user.

As shown in FIG. 2, the first connection management circuit 80 and the second connection management circuit 85 also share a memory 205. Because the memory 205 is shared among the first and second connection management circuits 80, 85, (i.e., the memory 205 is coupled to both the first data connector 30 and the second data connector 35), both the first electronic device 15a and the second electronic device 15b have access to information stored in the memory 205. The memory 205 allows the first electronic device 15a and the second electronic device 15b to directly share information with each other and with any devices connected to the docking station 10 (e.g., external mass storage devices). In other words, when the first electronic device 15a and the second electronic device 15b are connected to the first data connector 30 and the serial connector, respectively, the first electronic device 15a and the second electronic device 15b can transfer data between each other.

A user can transfer files to/from the first electronic device 15a, the second electronic device 15b, or another electronic device (e.g., an external flash disk or USB file storage device) by utilizing a graphical user interface (GUI) provided on the first electronic device 15a or the second electronic device 15b. For example, if a USB memory device is connected to the input/output port 60, files from the USB memory device can be copied to/from the first electronic device 15a using the GUI from the first electronic device 15a. In addition, files from the USB memory device can similarly be copied to/from the second electronic device 15b using the GUI provided by the second electronic device 15b. When a first electronic device 15a is not coupled to the docking station 10, the second electronic device 15b is connected to an external electronic device connected to the input/output ports 60, 65, allowing files to be transferred to and from the external electronic device and the second electronic device 15b using the GUI provided by the second electronic device 15b.

In another example, a user connects both the first electronic device 15a and the second electronic device 15b to the docking station 10. Then, the user selects data stored in the first electronic device 15a (e.g., a music file or folder) and stores it temporarily in the memory unit 205. The user then selects the data temporarily stored in the memory unit 205 and transfers the data to the second electronic device 15b for storage. In the illustrated embodiment, the user may delete, “copy,” and/or “paste” data from one device 15a-b to another. In some embodiments, a click-and-drag user interface may be used to share data between the electronic devices 15a-b and/or other electronic devices coupled to the docking station 10.

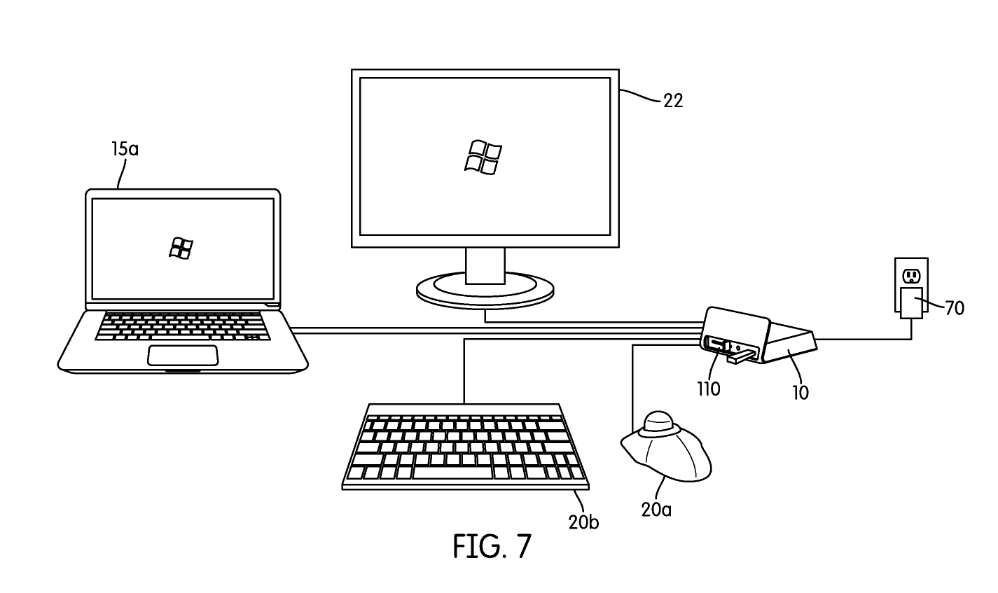

FIG. 4 illustrates the docking station 10 when only the first electronic device 15a is connected to the docking station 10. In such instances, the docking station 10, in particular the first connection management circuit 80, automatically associates all additional functionality of the docking station 10 with the first electronic device 15a. Therefore, the control switches 130, 175, 180, 190 are in the first position to be connected to the first electronic device 15a. FIG. 7 is a perspective view of the first electronic device 15a, the docking station 10, the display 22, and the peripheral devices 20a-b, when only the first electronic device 15a is connected to the docking station 10.

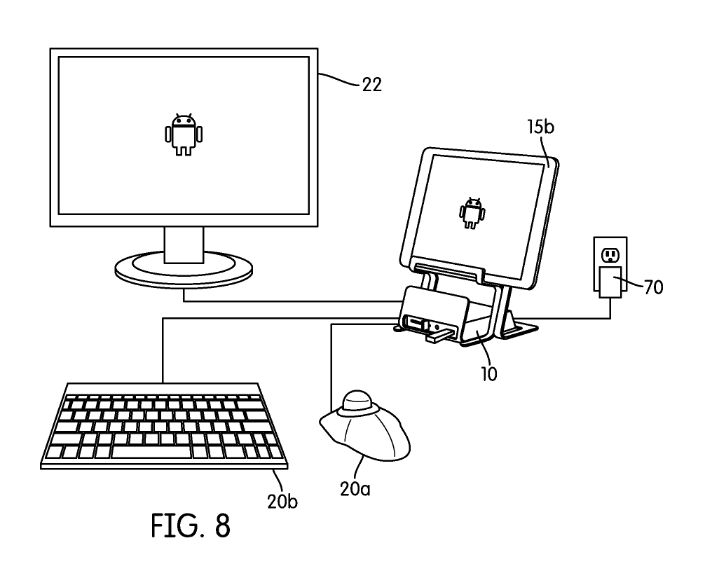

FIG. 5 illustrates the docking station 10 when only the second electronic device 15b is connected. In such instances, the docking station, and the second connection management circuit 85 in particular, automatically associates all additional functionality of the docking station 10 to the second electronic device 15b. Therefore, the control switches 130, 175, 180, 190 are in the second position to be connected to the second electronic device 15b. FIG. 8 is a perspective view of the second electronic device 15b, the docking station 10, the display 22, and the peripheral devices 20a-b, when only the second electronic device 15b is connected to the docking station 10.

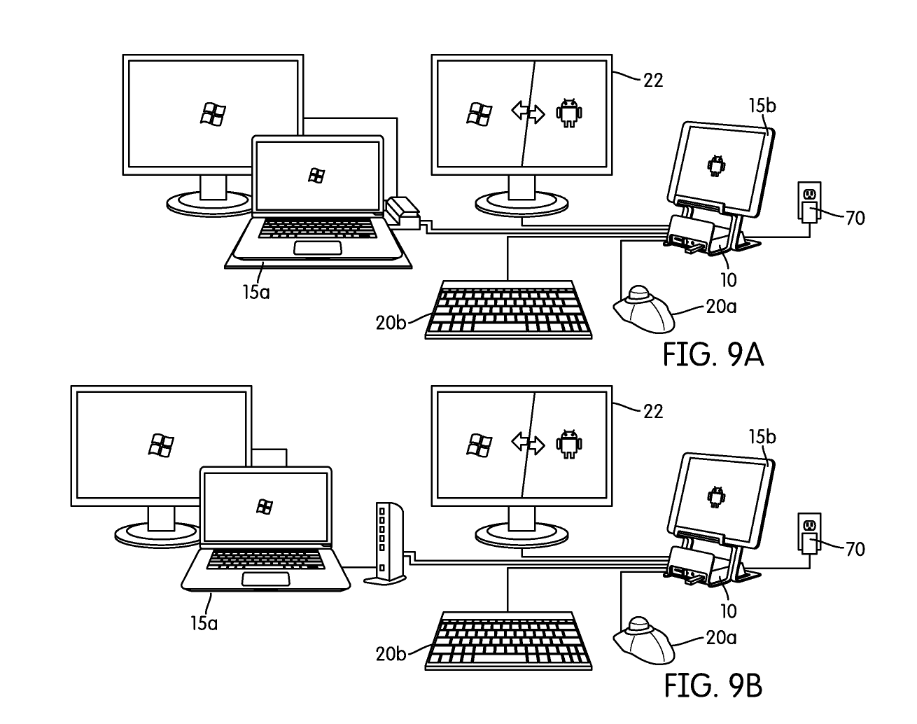

As shown in FIGS. 9A-B, the docking station 10 does not need a direct connection to the first electronic device 15a. In some embodiments, the first electronic device 15a may be connected to an OEM dock (FIG. 9A) or to a USB PC dock (FIG. 9B). In such embodiments, the docking station 10 connects via the video connector 25 and the first data connector 30 to the OEM or the USB PC dock. The first electronic device 15a can then utilize different display monitors as enabled by the associated dock and may potentially also use the external display 22 associated with the docking station 10.

As shown in FIG. 10, the docking station 10 includes a housing 210. The housing 210 is coupled to a support structure 213 configured to physically support at least a portion of the second electronic device 15b. The support structure 213 includes two support arms 215a-b that create a stand or cradle 220 for the second electronic device 15b. The stand 220 includes the second data connector 35 such that the second electronic device 15b can simply be placed on the stand 220 and connected to the docking station without excess or loose cables. Although the user controlled actuators 135, 185, 200, 203 are shown on the side of the docking station 10, in other embodiments, the control actuators 135, 185, 200, 203 may be positioned elsewhere on the docking station 10.

Although the docking station 10 has been described with physical actuators 135, 185, 200, 203 to control the switching functionality of the docking station 10, in some embodiments, the actuators 135, 185, 200, 203 may be software-implemented actuators. For example, the operating systems of the first electronic device 15a and the second electronic device 15b can run an application that allows the user to control, via software-implemented actuators, which functions/ports are associated with each electronic device 15a-b. For example, the first and connection management circuits 80, 85 may communicate with the application running on the first electronic device 15a, the second electronic device 15b, or both and determine based on user inputs received through the application how to make the connections within the docking station.

FIG. 11 shows an example of a user interface presented to a user to control the connections to the different ports 40, 45, 50, 55, 60, 65 of the docking station 10. As shown in FIG. 11, the docking station 10 may generate a GUI including various virtual actuators. The GUI may present the different actuators to the user and may request the user to select which ports 40, 45, 50, 55, 60, 65 are to be associated with each electronic device 15a-b connected to the docking station 10.

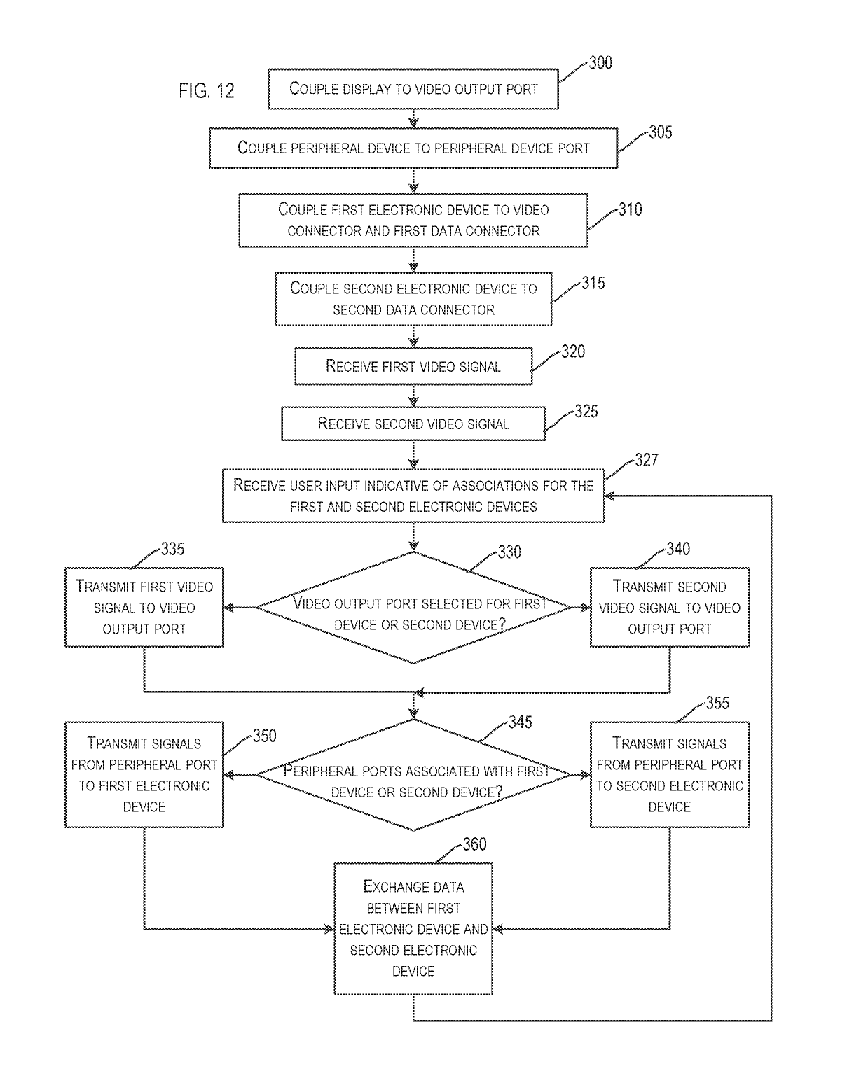

FIG. 12 illustrates a method of operating the docking station 10. In step 300, a user couples the display 22 to the video output port 55. The user then continues to couple at least one peripheral device 20a-b to one of the peripheral device ports 40, 45 (step 305), the first electronic device 15a to the video connector 25 and to the first data connector 30 (step 310), and the second electronic device 15b to the second data connector 35 (step 315). The docking station 10 (i.e., the control circuit 75) then receives a video signal from the first electronic device 15a through the video connector 25 (step 320) and receives another video signal (e.g., a second video signal) from the second electronic device 15b through the second data connector 35 (step 325). The docking station 10 also receives a user input (e.g., through a graphical user interface and/or physical actuators) that indicate whether each of the display 22, the peripheral devices 20a-b, the audio output port 50, and/or the other ports 60, 65 are associated with the first electronic device 15a and/or the second electronic device 15b (step 327).

The docking station 10 then determines, based on the received user input(s), whether the video output port 55 is selected to receive the first video signal and/or the second video signal (step 330). When the docking station 10 determines that the video output port 55 is selected to display the first video signal, the docking station 10 transmits the first video signal to the video output port 55 through a first communication path 126 that bypasses the video processor 128 (step 335). When the docking station 10 determines that the video output port 55 is selected to display the second video signal, the docking station 10 transmits the second video signal to the video output port 55 through a second communication path 127 that includes the video processor 128 (step 340).

The docking station 10 also determines whether the peripheral port(s) are selected to transmit information to the first electronic device 15a and/or the second electronic device 15b (step 345). When the docking station 10 determines that the connected peripheral device is selected to transmit data to the first electronic device 15a, the docking station 10 transmits the data signals from the peripheral port(s) 40, 45 to the first data connector 30 (step 350). On the other hand, when the docking station 10 determines that the connected peripheral device(s) are selected to transmit data to the second electronic device 15c, the docking station 10 transmits the data signals from the peripheral port(s0 40, 45 to the second data connector 35 (step 355).

In some embodiments, the docking station 10 also exchanges data between the first electronic device 15a and the second electronic device 15b via the shared memory 205 (step 360).

Thus, the invention provides, among other things, a docking station that selectively provides additional functionality to a first electronic device and a second electronic device. Various features and advantages of the invention are set forth in the following claims.

What is claimed is:

1. A docking station for use with a first electronic device, a second electronic device, a display, and a peripheral device, the docking station comprising:
a first port configured to couple to the display;
a second port configured to couple to the peripheral device;
a first connector configured to receive a first video signal from the first electronic device;
a second connector configured to receive a second video signal from the second electronic device; and
a control circuit coupled to the first port, the second port, the first connector, and the second connector, the control circuit including
a video processor operable to decompress video signals,
a first electrical communication path formed by the first connector and the first port, and bypassing the video processor, the first electrical communication path selectively transmitting the first video signal from the first connector to the first port, and
a second electrical communication path formed by the second connector, the video processor, and the first port, the second electrical communication path selectively transmitting the second video signal from the second connector, through the video processor, and to the first port.

2. The docking station of claim 1 further comprising a third connector configured to transmit a first data signal to the first electronic device and selectively receive the first data signal from the peripheral device through the second port.

3. The docking station of claim 2, wherein the first connector is connected to the first electronic device by an HDMI cable, and wherein the third connector is connected to the first electronic device by a USB cable.

4. The docking station of claim 2, wherein the second connector is further configured to transmit a second data signal to the second electronic device and selectively receive the second data signal from the peripheral device through the second port, and wherein the control circuit is operable to alternately connect the second connector and the third connector to the second port.

5. The docking station of claim 2 further comprising a memory, and wherein the second connector and the third connector are electrically coupled to the memory to transfer data between the first electronic device and the second electronic device.

6. The docking station of claim 1, wherein the first connector is a first type of connector, and wherein the second connector is a second type of connector that is different than the first type of connector.

7. The docking station of claim 1 further comprising a support structure configured to support at least a portion of the second electronic device.

8. The docking station of claim 7, wherein the support structure includes a cradle, and wherein the second connector is positioned on the cradle.

9. The docking station of claim 1, wherein the control circuit is further operable to
receive, by an actuator, a user input; and
selectively complete the first electrical communication path and the second electrical communication path based on the received user input.

10. The docking station of claim 10, wherein the actuator includes a virtual actuator, and wherein the docking station generates a graphical user interface including the virtual actuator.

11. A method of sharing a display and a peripheral device among a first electronic device and a second electronic device using a docking station including a first port, a second port, a first connector, a second connector, and a control circuit having a video processor that is operable to decompress video signals, the method comprising:
coupling the display to the first port of the docking station;
coupling the peripheral device to the second port of the docking station;
coupling the first electronic device to the first connector of the docking station;
coupling the second electronic device to the second connector of the docking station;
receiving, by the first connector, a first video signal from the first electronic device;
receiving, by the second connector, a second video signal from the second electronic device;
selectively transmitting the first video signal to the display via a first electrical communication path formed by the first connector and the first port, and bypassing the video processor of the control circuit;
selectively transmitting the second video signal to the display via a second electrical communication path formed by the second connector, the video processor, and the first port; and
decompressing, by the video processor, the second video signal.

12. The method of claim 11, wherein the docking station further includes a third connector, and further comprising:
selectively receiving, by the third connector, a first data signal from the peripheral device through the second port; and
transmitting, by the third connector, the first data signal to the first electronic device.

13. The method of claim 12 further comprising:
selectively receiving, by the second connector, a second data signal from the peripheral device through the second port; and
transmitting, by the second connector, the second data signal to the second electronic device.

14. The method of claim 13 further comprising alternately connecting, by the control circuit, the second connector and the third connector to the second port.

15. The method of claim 12, wherein the docking station further includes a memory, and further comprising:
coupling the first electronic device to the memory of the docking station;
coupling the second electronic device to the memory of the docking station; and
transferring data, via the memory, between the first electronic device and the second electronic device.

16. The method of claim 11, wherein receiving the first video signal includes receiving the first video signal from the first electronic device using a first communication protocol; and wherein receiving the second video signal includes receiving the second video signal from the second electronic device using a second communication protocol, the second communication protocol being different than the first communication protocol.

17. The method of claim 11 further comprising physically supporting, by a support structure of the docking station, at least a portion of the second electronic device while receiving the second video signal from the second electronic device.

18. The method of claim 11, wherein the docking station also includes an actuator, and further comprising:
receiving, by the actuator, a user input; and
selectively completing, by the control circuit, the first communication path and the second communication path based on the user input.

19. The method of claim 11, further comprising:
receiving, by the control circuit, a user input; and
selectively completing, by the control circuit, the first communication path and the second communication path based on the user input.

20. The method of claim 19, further comprising:
generating, by the control circuit, a graphical user interface including at least one virtual actuator, and
wherein receiving the user input includes receiving the user input through the at least one virtual actuator.
